(19) United States
(12) Patent Application Publication
(10) Pub. No.: US 2021/0072929 A1
(43) Pub. Date: Mar. 11, 2021

(54) INFORMATION PROCESSING DEVICE, IMAGE FORMING SYSTEM, AND NON-TRANSITORY COMPUTER READABLE MEDIUM STORING A PROGRAM

(71) Applicant: FUJI XEROX CO., LTD., Tokyo (JP)

(72) Inventors: Shingo TAJIMA, Kanagawa (JP); Megumi YAMAGUCHI, Kanagawa (JP); Takashi KIKUMOTO, Kanagawa (JP); Daisuke NOGUCHI, Kanagawa (JP); Shogo ISHIKAWA, Kanagawa (JP); Bo LIU, Kanagawa (JP); Masatake KAWABE, Kanagawa (JP)

(73) Assignee: FUJI XEROX CO., LTD., Tokyo (JP)

(21) Appl. No.: 16/830,600

(22) Filed: Mar. 26, 2020

(30) Foreign Application Priority Data
Sep. 10, 2019 (JP) 2019-164555

(51) Int. Cl. G06F 3/12

(52) U.S. Cl. CPC G06F 3/1203; G06F 3/1215; G06F 3/1237

(57) ABSTRACT

An information processing device including a processor is configured to: convert data for which a data print instruction has been issued, into image data of a format used for image forming carried out by an image former, and store the image data in a memory; cause the image forming, which is based on the image data stored in the memory, to be carried out with respect to a recording medium that is continuously conveyed by a conveyor; and control a conveying speed of the recording medium being conveyed by the conveyor, on the basis of the image data stored in the memory.

### CROSS-REFERENCE TO RELATED APPLICATIONS

This application is based on and claims priority under 35 USC 119 from Japanese Patent Application No. 2019-164555 filed Sep. 10, 2019.

### BACKGROUND

### (i) Technical Field

The present disclosure relates to an information processing device, an image forming system, and a non-transitory computer readable medium storing a program.

### (ii) Related Art

Japanese Unexamined Patent Application Publication No. 2014-21299 describes that a periodic change in the conveyance amount of continuous paper caused by the eccentricity of an idle roller and a periodic change in the conveyance amount of continuous paper caused by the eccentricity of an idle roller cancel out each other.

Japanese Unexamined Patent Application Publication No. 2015-30228 describes that, in a case where a change in the conveying speed of continuous paper causes a change in the vibration state of a meniscus that is in effect when a drive waveform is applied to a driving element, a drive controller controls an application unit to cause the drive waveform to be applied to the driving element when the vibration state of the meniscus is similar to before the change in the conveying speed of the continuous paper.

Japanese Patent No. 4650357 describes that an IOT is controlled such that a skip page is inserted in a case where a buffer retention amount falls below a specified threshold value determined in advance and the amount of change in the buffer retention amount of an output buffer from the previous check timing to the current check timing has become negative.

### SUMMARY

There are cases where an information processing device, upon receiving a data print instruction, converts the data for which the instruction has been received into image data of a format used for image forming carried out by an image former. The converted image data is stored in a memory and thereafter used for image forming.

Here, there are cases where the conveyance of a recording medium to be conveyed continuously is started and printing for the recording medium is started before all of the data to be printed has been converted into image data. In this case, for example, when the printing speed is faster than the image data conversion speed due to the recording medium conveying speed being fast, the image data conversion is not in synchronization with the printing, and there may be some pages of the recording medium on which printing has not been carried out. Furthermore, for example, in a case where the recording medium conveying speed is slow, the printing speed may become slow and the time required for printing may increase.

Aspects of non-limiting embodiments of the present disclosure relate to controlling a conveying speed on the basis of image data stored in a memory, in a case where data for which a data print instruction has been issued is to be converted into image data of a format used for image forming carried out by an image former.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to: convert data for which a data print instruction has been issued, into image data of a format used for image forming carried out by an image former, and store the image data in a memory; cause the image forming, which is based on the image data stored in the memory, to be carried out on a recording medium that is continuously conveyed by a conveyor; and control a conveying speed of the recording medium being conveyed by the conveyor, on the basis of the image data stored in the memory.

### BRIEF DESCRIPTION OF THE DRAWINGS

An exemplary embodiment of the present disclosure will be described in detail based on the following figures, wherein:

FIG. 1 is a drawing depicting an example of an overall configuration of an image forming system according to the present exemplary embodiment;

FIG. 2 is a drawing depicting a configuration of an image forming device;

FIG. 3 is a drawing depicting a hardware configuration of a server device;

FIG. 4 is a block diagram depicting an example of a functional configuration of the server device;

FIG. 5 is a flowchart depicting the flow of printing preparation processing;

FIG. 6 is a flowchart depicting the flow of speed control processing;

FIG. 7 is a drawing depicting the relationship between the amount of image data stored in a storage device and the printing speed during printing;

FIG. 8A is a drawing depicting changes in printing speed with respect to time, and FIG. 8B is a drawing depicting changes in the amount of image data stored in the storage device with respect to time; and

FIG. 9A is a drawing depicting changes in printing speed with respect to time, and FIG. 9B is a drawing depicting changes in the amount of image data stored in the storage device with respect to time.

### DETAILED DESCRIPTION

Hereinafter, an exemplary embodiment of the present disclosure will be described in detail with reference to the appended drawings. As used herein, “a processor” can mean one processor that executes a process or more than one processor that collaborate to execute the process.

### <Configuration of Image Forming System>

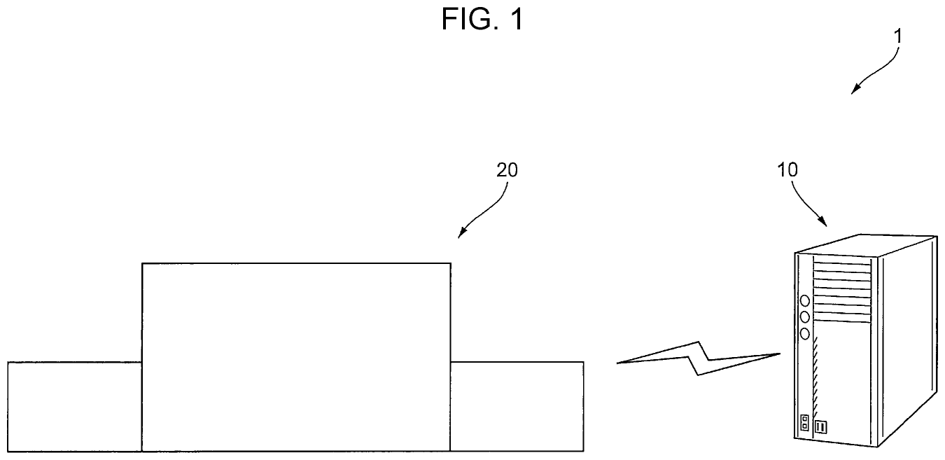

FIG. 1 is a drawing depicting an example of an overall configuration of an image forming system 1 according to the present exemplary embodiment. The image forming system 1 of the present exemplary embodiment is provided with a server device 10 and an image forming device 20. The server device 10 and the image forming device 20 are connected via a network.

The server device 10 serves as an example of an information processing device, and is a server that transmits and receives data with the image forming device 20 via the network. The server device 10 is realized by a computer, for example. The server device 10 may be constituted by a single computer or may be realized by distributed processing carried out by multiple computers.

The image forming device 20 of the present exemplary embodiment is an ink jet printer that forms images by discharging ink onto continuous paper P. The continuous paper P is paper in which pages are continuously formed in the paper conveyance direction. Examples of the continuous paper P include rolled paper, continuous form paper, and the like. Here, the continuous paper P is treated as a recording medium that is continuously conveyed by a first conveying roller 209 and a second conveying roller 210 (both described later).

There is no particular restriction to the type of network that connects the server device 10 and the image forming device 20 as long as it is possible to transmit and receive data. The communication line used to transmit and receive data may be wired or wireless.

### <Configuration of Image Forming Device>

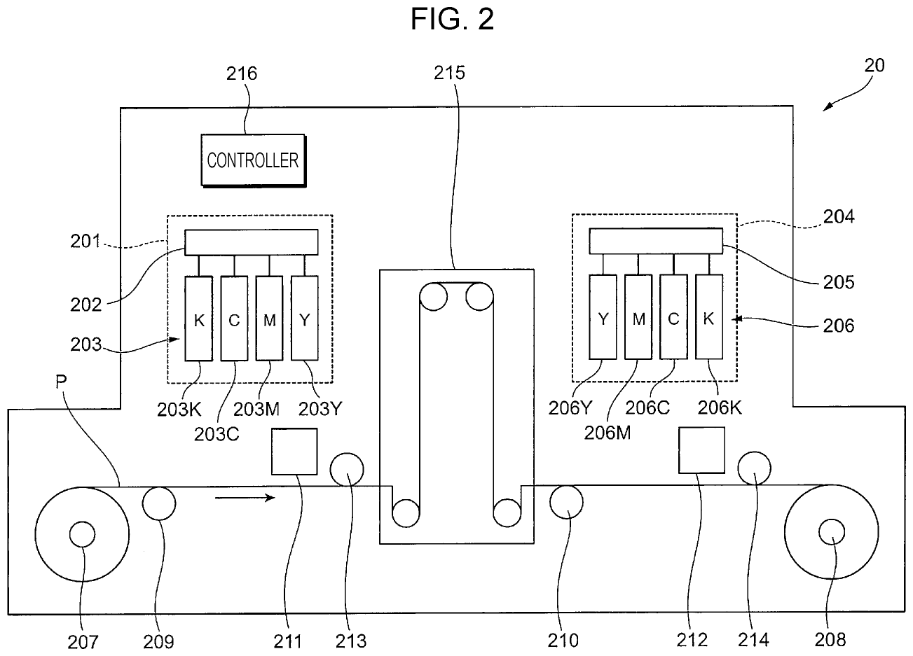

FIG. 2 is a drawing depicting a configuration of the image forming device 20.

The image forming device 20 of the present exemplary embodiment has a first image former 201, a second image former 204, a supplier 207, a winding unit 208, the first conveying roller 209, the second conveying roller 210, a first drier 211, a second drier 212, a first cooler 213, a second cooler 214, a buffer device 215, and a controller 216.

The first image former 201 serves as an example of an image former, and forms images on the front surface of the continuous paper P on the basis of image data. The first image former 201 is provided with four first ink jet heads including a first ink jet head 203Y for yellow (Y), a first ink jet head 203M for magenta (M), a first ink jet head 203C for cyan (C), and a first ink jet head 203K for black (K), respectively corresponding to inks of the four colors of yellow (Y), magenta (M), cyan (C), and black (K). It should be noted that, in the description given hereinafter, the first ink jet heads will be referred to as the first ink jet heads 203 when described without distinguishing therebetween.

The first ink jet heads 203 form images on the continuous paper P by discharging ink droplets using a publicly-known method such as a thermal system or a piezoelectric system. The first ink jet heads 203 have lengths that correspond to a width that is greater than or equal to a region where images are formed on the continuous paper P. Furthermore, the first ink jet heads 203 are provided with nozzles for discharging ink across the entire width of the region where images are formed on the continuous paper P.

Furthermore, the first image former 201 is provided with a first driver 202 that drives the four first ink jet heads 203. The first driver 202 causes the first ink jet heads 203 to move and ink to be dripped from the first ink jet heads 203.

The second image former 204 serves as an example of an image former, and forms images on the rear surface of the continuous paper P on the basis of image data. The second image former 204 is provided with four second ink jet heads including a second ink jet head 206Y for yellow (Y), a second ink jet head 206M for magenta (M), a second ink jet head 206C for cyan (C), and a second ink jet head 206K for black (K), respectively corresponding to inks of the four colors of yellow (Y), magenta (M), cyan (C), and black (K). Furthermore, the second image former 204 is provided with a second driver 205 that drives the four second ink jet heads. It should be noted that, in the description given hereinafter, the second ink jet heads will be referred to as the second ink jet heads 206 when described without distinguishing therebetween. Furthermore, the first ink jet heads 203 and the second ink jet heads 206 will be referred to simply as the ink jet heads when described without distinguishing therebetween.

The second image former 204 has a similar configuration to that of the first image former 201.

The supplier 207 accommodates the continuous paper P. Furthermore, the supplier 207 supplies the continuous paper P downstream in the paper conveyance direction.

The winding unit 208 winds in continuous paper P that has an image formed thereon.

The first conveying roller 209 serves as an example of a conveying unit, and conveys the continuous paper P supplied from the supplier 207, toward a location where ink that is discharged from the first ink jet heads 203 drips. The first conveying roller 209 of the present exemplary embodiment is provided with a motor (not depicted). When the rotation speed of the motor provided in the first conveying roller 209 changes, the conveying speed of the continuous paper P implemented by the first conveying roller 209 changes.

The second conveying roller 210 serves as an example of a conveying unit, and conveys the continuous paper P toward a location where ink that is discharged from the second ink jet heads 206 drips. The second conveying roller 210 of the present exemplary embodiment is provided with a motor (not depicted). When the rotation speed of the motor provided in the second conveying roller 210 changes, the conveying speed of the continuous paper P implemented by the second conveying roller 210 changes.

The first drier 211 serves as an example of a drier, and dries ink that has been discharged from the first ink jet heads 203 and has adhered to the front surface of the continuous paper P. More specifically, the first drier 211 supplies hot air to the continuous paper P to dry ink that has adhered to the front surface of the continuous paper P.

The second drier 212 serves as an example of a drier, and dries ink that has been discharged from the second ink jet heads 206 and has adhered to the rear surface of the continuous paper P. More specifically, the second drier 212 supplies hot air to the continuous paper P to dry ink that has adhered to the rear surface of the continuous paper P.

The first drier 211 and the second drier 212 of the present exemplary embodiment are both provided in such a way that it is possible to adjust the temperature of the hot air.

It should be noted that a roller member, for example, may be used instead of the first drier 211 and the second drier 212. The roller member, for example, comes into contact with the continuous paper P and supplies heat to the continuous paper P, thereby drying ink that has adhered to the continuous paper P. A roller member that supplies heat to the continuous paper P is therefore also considered to be a drier.

The first cooler 213 serves as an example of a cooler, and is a roller member that cools the continuous paper P. The first cooler 213 comes into contact with the front surface of the continuous paper P dried by the first drier 211 and cools the continuous paper P.

The second cooler 214 serves as an example of a cooler, and is a roller member that cools the continuous paper P. The second cooler 214 comes into contact with the rear surface of the continuous paper P dried by the second drier 212 and cools the continuous paper P.

The first cooler 213 and the second cooler 214 of the present exemplary embodiment are both provided in such a way that it is possible to adjust the cooling temperature.

It should be noted that an air blower, for example, may be used instead of the first cooler 213 and the second cooler 214. This air blower supplies cold air to the continuous paper P and cools the continuous paper P, for example. An air blower that supplies cold air onto the continuous paper P is therefore also considered to be a cooler.

The buffer device 215 has an inverting mechanism that inverts between the front surface and the rear surface of the continuous paper P. The buffer device 215 is provided downstream in the conveyance direction from the first cooler 213, and upstream in the conveyance direction from the second conveying roller 210.

The controller 216, upon receiving a data print instruction from the server device 10, controls the operation of the first image former 201 and the second image former 204 on the basis of the print instruction and image data. The controller 216 causes image forming to be carried out on the continuous paper P at the timing at which the continuous paper P is conveyed to a discharge location. The discharge location is a location where ink that is discharged from the ink jet heads drips. The discharge location is an example of a predetermined location.

The controller 216 of the present exemplary embodiment controls the conveying speed of the continuous paper P by controlling the rotation speed of the motor of the first conveying roller 209 and the rotation speed of the motor of the second conveying roller 210. Furthermore, the controller 216 controls the printing speed by controlling the timing at which ink is discharged by the ink jet heads, in accordance with the conveying speed of the continuous paper P. Furthermore, the controller 216 controls the drying temperatures implemented by the first drier 211 and the second drier 212. In addition, the controller 216 controls the cooling temperatures implemented by the first cooler 213 and the second cooler 214.

It should be noted that the image forming device 20 is not restricted to being a color printer. The image forming device 20 may be a monochrome printer that forms images of a predetermined color. The predetermined color is black, for example.

### <Configuration of Server Device>

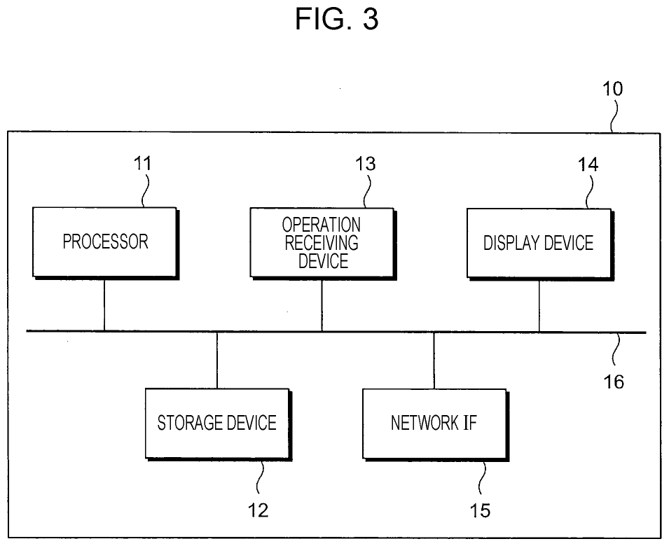

Next, a hardware configuration of the server device 10 will be described. FIG. 3 is a drawing depicting a hardware configuration of the server device 10.

The server device 10 has: a processor 11 that controls the operation of the server device 10 and the operation of the image forming device 20 by executing a program; a storage device 12 that stores the program executed by the processor 11 and various types of data; an operation receiving device 13 that receives a user operation; a display device 14 that displays an operation screen that the user confirms; and a network IF (interface) 15 that realizes communication with the image forming device 20. There units are connected by a signal line 16 such as a data bus, an address bus, a PCI (peripheral component interconnect) bus, or the like.

The processor 11 is constituted by a CPU, for example. The processor 11 executes processing that is based on the program stored in the storage device 12, thereby realizing various types of functions.

The storage device 12 serves as an example of a memory, and is constituted by a ROM in which a BIOS (basic input output system) or the like is stored, a RAM that is used as a work area, and a hard disk device in which a basic program, an application program, or the like is stored. Naturally, the ROM and RAM are not precluded from being included in part of the processor 11.

The operation receiving device 13 is constituted by a keyboard, a mouse, mechanical buttons, switches, or the like. It should be noted that the operation receiving device 13 also includes touch sensors constituting a touch panel in an integral manner with the display device 14.

The display device 14 is constituted by a liquid crystal display or an organic EL (electroluminescence) display used to display information.

### <Functional Configuration of Server Device>

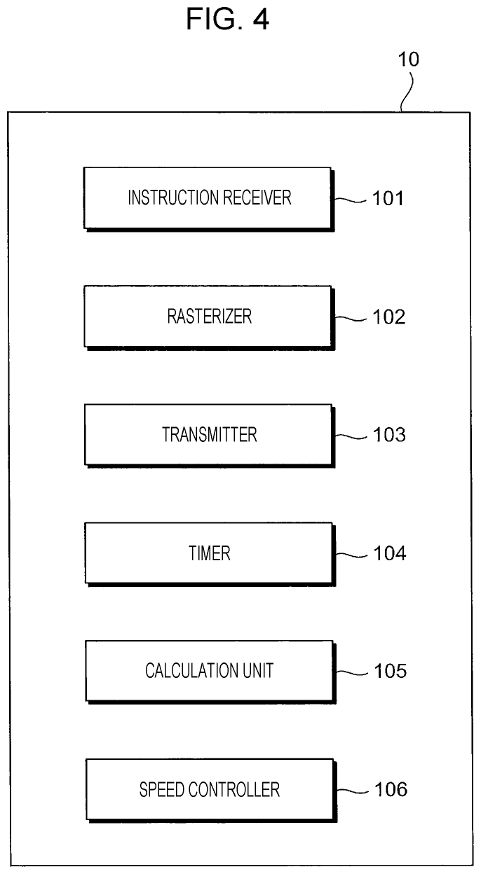

Next, a functional configuration of the server device 10 will be described. FIG. 4 is a block diagram depicting an example of a functional configuration of the server device 10.

FIG. 4 depicts some of the functions that are realized by the processor 11 executing an application program.

The server device 10 is provided with an instruction receiver 101, a rasterizer 102, a transmitter 103, a timer 104, a calculation unit 105, and a speed controller 106.

The instruction receiver 101 receives a print instruction from the user, and acquires print data for which the print instruction has been issued. The print data is PDL (page description language) data, for example. The PDL data is written in a page description language.

The rasterizer 102 converts print data into image data of a format used for image forming carried out by the first image former 201 (see FIG. 2) and the second image former 204. The image data is bitmap data, for example. The rasterizer 102 stores converted image data in the storage device 12. In other words, in the present exemplary embodiment, image data converted by the rasterizer 102 is accumulated in the storage device 12.

The transmitter 103 transmits the print instruction and image data to the image forming device 20. More specifically, the transmitter 103 notifies the print instruction received by the instruction receiver 101 to the controller 216 of the image forming device 20, and transmits image data that is the subject of the instruction and is stored in the storage device 12 to the controller 216. The image data transmitted at such time is image data for the first single page from among all of the image data to be printed.

It should be noted that, in the present exemplary embodiment, the image data transmitted to the controller 216 does not remain in the storage device 12. In other words, when the image data is transmitted from the storage device 12 to the image forming device 20 by the transmitter 103, the amount of image data stored in the storage device 12 decreases. Furthermore, during printing, each time a single page is printed by the image forming device 20, image data for the next single page is transmitted from the storage device 12 to the image forming device 20.

The timer 104 measures time. At each predetermined time interval, the timer 104 of the present exemplary embodiment notifies the calculation unit 105 that this predetermined time interval has been reached. The predetermined time interval may be any length. The predetermined time interval is 10 seconds, for example.

In the present exemplary embodiment, each time the timer 104 measures that the predetermined time interval has been reached during printing, the server device 10 confirms the image data stored in the storage device 12, and controls the conveying speed of the continuous paper P on the basis of the confirmation result. The point in time at which the predetermined time interval is reached will be referred to as a checkpoint (CP) hereinafter.

The calculation unit 105 calculates an amount of change in the amount of image data stored in the storage device 12. The calculation unit 105 receives a notification from the timer 104 each time a CP is reached, and calculates the amount of image data stored in the storage device 12. The calculation unit 105 then calculates the amount of change in the amount of image data stored in the storage device 12 by subtracting the amount of image data calculated upon reaching the previous CP from the amount of image data calculated upon reaching the current CP. The calculation unit 105 transmits information relating to the calculation result for the amount of change, and the amount of image data calculated upon reaching the current CP, to the speed controller 106. It should be noted that the “current CP” refers to the most recent CP. Furthermore, the “previous CP” refers to the CP immediately prior to the “current CP”.

The speed controller 106 controls the conveying speed of the continuous paper P. The speed controller 106 controls the conveying speed of the continuous paper P on the basis of the information acquired from the calculation unit 105. It should be noted that a condition for the speed controller 106 to carry out control will be described in detail later.

### <Printing Preparation Processing>

Next, the flow of printing preparation processing carried out by the server device 10 will be described. The printing preparation processing is processing in which the server device 10 prepares for printing that has been instructed. The printing preparation processing is started due to the instruction receiver 101 of the server device 10 receiving a print instruction.

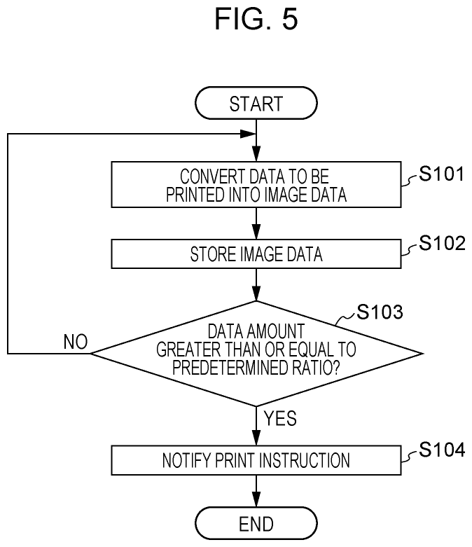

FIG. 5 is a flowchart depicting the flow of the printing preparation processing.

First, the rasterizer 102 converts print data for which a print instruction has been issued, into image data (S101). More specifically, from among the printing that has been instructed, the rasterizer 102 converts the first page of the print data to be printed, into image data.

The rasterizer 102 stores the converted image data in the storage device 12 (S102).

The rasterizer 102 determines whether or not the ratio of the amount of print data for which conversion into image data has been completed, with respect to the total amount of print data for which a print instruction has been issued, is greater than or equal to a predetermined ratio (S103). The predetermined ratio may be any value. The predetermined ratio is 50%, for example.

In a case where the ratio of the amount of data is less than the predetermined ratio (no in S103), processing returns to step 101, and the rasterizer 102 converts the print data to be printed for the next page into image data. Here, the “next page” refers to the page that is subsequent to the most recent page for which image data conversion by the rasterizer 102 has been completed. In this way, the processing of step 101 and thereafter is carried out repeatedly until the ratio of the amount of print data for which conversion into image data has been completed becomes greater than or equal to the predetermined ratio.

However, in a case where a positive result is obtained in step 103, the transmitter 103 notifies a print instruction to the controller 216 of the image forming device 20 (S104). Furthermore, the transmitter 103 transmits image data stored in the storage device 12 to the controller 216. The controller 216, upon receiving the print instruction and acquiring the image data, causes the first conveying roller 209 and the second conveying roller 210 to start conveying the continuous paper P, and causes the first image former 201 and the second image former 204 to drive the ink jet heads. The printing that has been instructed is thereby started.

It should be noted that a print instruction and image data may be transmitted from the server device 10 to the controller 216 by the user carrying out an operation to start printing regardless of the amount of image data stored in the storage device 12.

Furthermore, in a case where the conversion into image data has not been completed for all print data for which a print instruction has been issued, the conversion into image data by the rasterizer 102 is carried out also after printing has been started. In this case, the amount of image data stored in the storage device 12 is liable to increase in a manner commensurate with an increase in the speed at which print data is converted into image data by the rasterizer 102. Furthermore, commensurate with an increase in the printing speed, the amount of image data stored in the storage device 12 is liable to decrease by an amount equivalent to the speed at which image data is transferred from the storage device 12 to the image forming device 20. In other words, the amount of image data stored in the storage device 12 is determined by the image data conversion speed implemented by the rasterizer 102 and the printing speed. More specifically, in a case where the image data conversion speed implemented by the rasterizer 102 is greater than the printing speed, the amount of image data stored in the storage device 12 increases as time elapses. Furthermore, in a case where the image data conversion speed implemented by the rasterizer 102 is less than the printing speed, the amount of image data stored in the storage device 12 decreases as time elapses.

### <Speed Control Processing>

Next, speed control processing will be described. The speed control processing is processing in which the server device 10 controls the conveying speed of the continuous paper P during printing. In the present exemplary embodiment, after the printing preparation processing (see FIG. 5) has completed and during printing, the speed control processing is started each time a CP is reached.

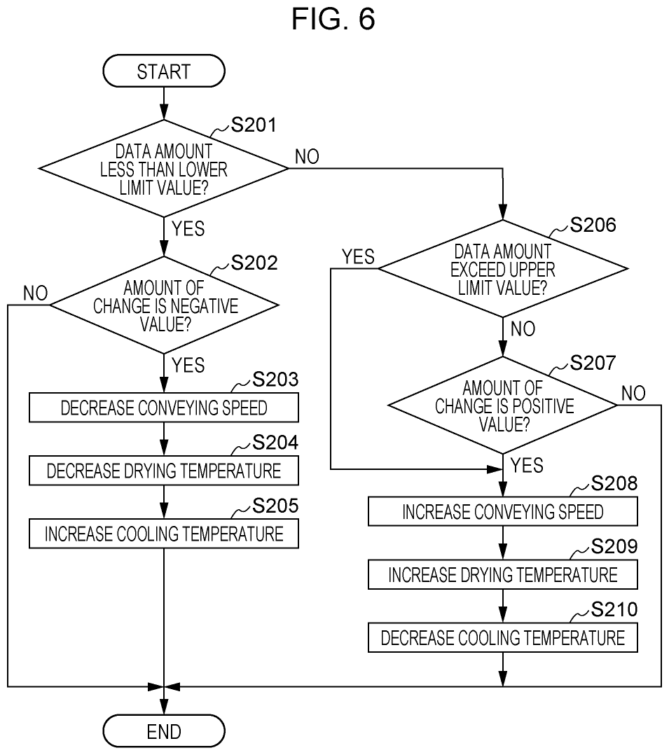

FIG. 6 is a flowchart depicting the flow of speed control processing.

First, the speed controller 106 determines whether or not the amount of image data stored in the storage device 12 is less than a lower limit value (S201). The speed controller 106 carries out this determination using information acquired from the calculation unit 105 upon reaching the current CP. Furthermore, the lower limit value is a value determined from the viewpoint of suppressing a situation where the image data conversion by the rasterizer 102 is out of synchronization with printing. The lower limit value will be described in detail later.

In a case where a positive result is obtained in step 201, the speed controller 106 determines whether or not the amount of change in the amount of image data stored in the storage device 12 is a negative value (S202). This amount of change is an amount of change in the amount of data at the current CP with respect to the amount of data at the previous CP.

In a case where the amount of change in the amount of data is a negative value (yes in S202), this signifies that the amount of image data stored in the storage device 12 is decreasing as time elapses. In this case, the speed controller 106 causes the conveying speed of the continuous paper P being conveyed to decrease (S203). More specifically, the speed controller 106 instructs the controller 216 of the image forming device 20 (see FIG. 2) to decrease the rotation speed of the motor of the first conveying roller 209 and the rotation speed of the motor of the second conveying roller 210 at a predetermined speed. Furthermore, the speed controller 106 controls the timing at which ink drips from the ink jet heads, in accordance with the conveying speed of the continuous paper P being decreased. More specifically, the speed controller 106 causes the printing speed to decrease in accordance with the decrease in the conveying speed of the continuous paper P, by instructing the controller 216 to synchronize the timing at which ink drips with the conveying speed of the continuous paper P.

The speed controller 106 instructs the controller 216 to decrease the drying temperature implemented by the first drier 211 and the drying temperature implemented by the second drier 212 (S204).

The speed controller 106 instructs the controller 216 to increase the cooling temperature implemented by the first cooler 213 and the cooling temperature implemented by the second cooler 214 (S205).

Furthermore, in a case where the amount of change in the amount of image data stored in the storage device 12 is not a negative value (no in S202), the speed control processing ends.

However, in a case where a negative result is obtained in step 201, the speed controller 106 determines whether or not the amount of image data stored in the storage device 12 exceeds an upper limit value (S206). The upper limit value is a value determined from the viewpoint of suppressing a situation where the storage device 12 does not have space for the image data converted by the rasterizer 102. The upper limit value will be described in detail later.

In a case where a negative result is obtained in step 206, the speed controller 106 determines whether or not the amount of change in the amount of image data stored in the storage device 12 is a positive value (S207). This amount of change is an amount of change in the amount of data at the current CP with respect to the amount of data at the previous CP. This amount of change being a positive value signifies that the amount of image data stored in the storage device 12 is increasing as time elapses.

In a case where the amount of change in the amount of data is not a positive value (no in S207), the speed control processing ends.

Furthermore, in a case where a positive result is obtained in step 207, or in a case where a positive result is obtained in step 206, the speed controller 106 causes the conveying speed of the continuous paper P being conveyed to increase (S208). More specifically, the speed controller 106 instructs the controller 216 to increase the rotation speed of the motor of the first conveying roller 209 and the rotation speed of the motor of the second conveying roller 210 at a predetermined speed. Furthermore, the speed controller 106 controls the timing at which ink drips from the ink jet heads, in accordance with the conveying speed of the continuous paper P being increased. More specifically, the speed controller 106 causes the printing speed to increase in accordance with the increase in the conveying speed of the continuous paper P, by instructing the controller 216 to synchronize the timing at which ink drips with the conveying speed of the continuous paper P.

The speed controller 106 instructs the controller 216 to increase the drying temperature implemented by the first drier 211 and the drying temperature implemented by the second drier 212 (S209).

The speed controller 106 instructs the controller 216 to decrease the cooling temperature implemented by the first cooler 213 and the cooling temperature implemented by the second cooler 214 (S210).

It should be noted that, in step 208, in a case where the rotation speed of the motor of the first conveying roller 209 and the rotation speed of the motor of the second conveying roller 210 have already reached the upper limit value for speed, the speed controller 106 maintains the conveying speed of the continuous paper P. In this case, the timing at which ink is dripped from the ink jet heads, the drying temperatures of the first drier 211 and the second drier 212, and the cooling temperatures of the first cooler 213 and the second cooler 214 are maintained at the current states.

As described above, in the present exemplary embodiment, the processor 11 of the server device 10 causes image forming that is based on image data stored in the storage device 12 to be carried out on the continuous paper P. The processor 11 then controls the conveying speed of the continuous paper P being conveyed using the first conveying roller 209 and the second conveying roller 210, on the basis of the image data stored in the storage device 12.

Furthermore, in the present exemplary embodiment, the processor 11 causes the conveying speed to decrease, on the basis of the amount of image data stored in the storage device 12 and changes in the amount of image data.

Furthermore, in the present exemplary embodiment, the processor 11 causes the conveying speed to increase, on the basis of the amount of image data stored in the storage device 12 and changes in the amount of image data.

Furthermore, in the present exemplary embodiment, the processor 11 causes the conveying speed to increase regardless of changes in the amount of image data stored in the storage device 12, in a case where the amount of image data stored in the storage device 12 is greater than the upper limit value.

Furthermore, in the present exemplary embodiment, the processor 11 causes the conveying speed to increase in a case where the amount of image data stored in the storage device 12 is greater than the lower limit value and the amount of change per predetermined time interval in the amount of data is a positive value.

Furthermore, in the present exemplary embodiment, the processor 11 causes the conveying speed to decrease in a case where the amount of image data stored in the storage device 12 is less than the lower limit value and the amount of change per predetermined time interval in the amount of data is a negative value. Furthermore, the conveying speed is increased in a case where the amount of data is greater than the lower limit value and the amount of change in the amount of data is a positive value. Also, the conveying speed is not increased in a case where the amount of data is greater than the lower limit value and the amount of change in the amount of data is a negative value.

When the conveying speed is increased in a case where the amount of data is greater than the lower limit value and the amount of change in the amount of data is a negative value, after the determination as to whether or not the conveying speed is to be increased, the time to the amount of data becoming less than the lower limit value and the amount of change in the amount of data becoming negative, namely the time to the conveying speed being decreased, becomes shorter compared to the case where the conveying speed is not increased. In this case, the conveying speed is increased and the conveying speed is decreased within a short period of time. Thus, in the present exemplary embodiment, by not increasing the conveying speed in a case where the amount of data is greater than the lower limit value and the amount of change in the amount of data is a negative value, after the determination as to whether or not the conveying speed is to be increased, the time from the conveying speed being increased to the conveying speed being decreased becomes longer compared to the case where the conveying speed is increased.

Furthermore, in the present exemplary embodiment, the processor 11, together with controlling the conveying speed, controls the drying temperatures implemented by the first drier 211 and the second drier 212, and controls the cooling temperatures implemented by the first cooler 213 and the second cooler 214.

### <Relationship Between Amount of Data and Printing Speed>

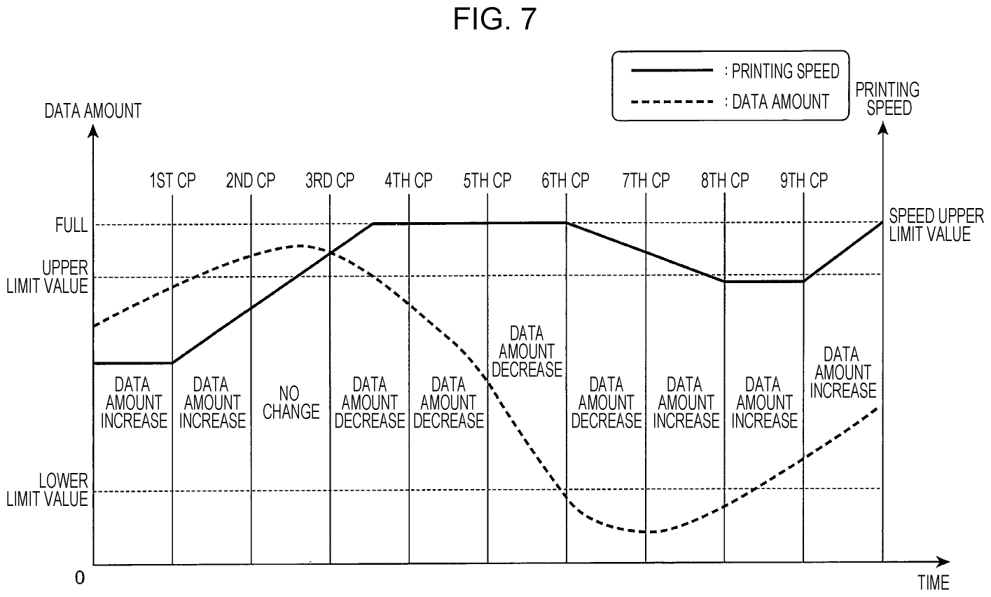

Next, the relationship between the amount of image data stored in the storage device 12 and the printing speed during printing will be described. FIG. 7 is a drawing depicting the relationship between the amount of image data stored in the storage device 12 and the printing speed during printing. It should be noted that the horizontal axis of the line graph depicted in FIG. 7 indicates the time that has elapsed from printing being started, and the vertical axis indicates the amount of image data stored in the storage device 12 and the printing speed.

First, printing is started according to a predetermined printing speed. In the example depicted in FIG. 7, when printing is started, the image data conversion speed implemented by the rasterizer 102 is greater than the printing speed. In this case, the amount of image data stored in the storage device 12 increases as time elapses.

Next, as time elapses, the first CP is reached and speed control processing (see FIG. 6) is carried out. At the first CP, the amount of image data stored in the storage device 12 is greater than the lower limit value (no in S201) and is less than the upper limit value (no in S206). Furthermore, at the first CP, the amount of image data stored in the storage device 12 is increasing (yes in S207) compared to when printing was started. In this case, the speed controller 106 causes the conveying speed of the continuous paper P to increase (S208) and causes the printing speed to increase. Even in this case, the image data conversion speed implemented by the rasterizer 102 is greater than the printing speed, and the amount of image data stored in the storage device 12 increases as time elapses.

Subsequently, as time elapses, the second CP is reached and speed control processing is carried out. At the second CP, the amount of image data stored in the storage device 12 is greater than the lower limit value (no in S201) and is greater than the upper limit value (yes in S206). In this case, the speed controller 106 further increases the conveying speed of the continuous paper P (S208) and further increases the printing speed. Thus, the printing speed becomes greater than the image data conversion speed implemented by the rasterizer 102.

Subsequently, as time elapses, the third CP is reached and speed control processing is carried out. At the third CP, the amount of image data stored in the storage device 12 is greater than the lower limit value (no in S201) and is greater than the upper limit value (yes in S206). Furthermore, the amount of image data stored in the storage device 12 at the third CP does not change from the amount of image data stored in the storage device 12 at the second CP. In this case, the speed controller 106 further increases the conveying speed of the continuous paper P (S208) and further increases the printing speed. Thus, the printing speed becomes even greater than the image data conversion speed implemented by the rasterizer 102. Therefore, the amount of image data stored in the storage device 12 decreases as time elapses.

Subsequently, as time elapses, the fourth CP is reached and speed control processing is carried out. At the fourth CP, the amount of image data stored in the storage device 12 is greater than the lower limit value (no in S201) and is less than the upper limit value (no in S206). Furthermore, at the fourth CP, the amount of image data stored in the storage device 12 is decreasing (no in S207) compared to the third CP. In this case, the speed controller 106 maintains the conveying speed of the continuous paper P and maintains the printing speed. Therefore, the amount of image data stored in the storage device 12 decreases as time elapses.

Subsequently, as time elapses, the fifth CP is reached and speed control processing is carried out. At the fifth CP, the amount of image data stored in the storage device 12 is greater than the lower limit value (no in S201) and is less than the upper limit value (no in S206). Furthermore, at the fifth CP, the amount of image data stored in the storage device 12 is decreasing (no in S207) compared to the fourth CP. In this case, the speed controller 106 maintains the conveying speed of the continuous paper P and maintains the printing speed. Therefore, the amount of image data stored in the storage device 12 decreases as time elapses.

Subsequently, as time elapses, the sixth CP is reached and speed control processing is carried out. At the sixth CP, the amount of image data stored in the storage device 12 is less than the lower limit value (yes in S201). Furthermore, at the sixth CP, the amount of image data stored in the storage device 12 is decreasing (yes in S202) compared to the fifth CP. In this case, the speed controller 106 causes the conveying speed of the continuous paper P to decrease (S203), and causes the printing speed to decrease. Even in this case, the printing speed is greater than the image data conversion speed implemented by the rasterizer 102, and the amount of image data stored in the storage device 12 decreases as time elapses.

Subsequently, as time elapses, the seventh CP is reached and speed control processing is carried out. At the seventh CP, the amount of image data stored in the storage device 12 is less than the lower limit value (yes in S201). Furthermore, at the seventh CP, the amount of image data stored in the storage device 12 is decreasing (yes in S202) compared to the sixth CP. In this case, the speed controller 106 causes the conveying speed of the continuous paper P to further decrease (S203), and causes the printing speed to further decrease. Thus, the image data conversion speed implemented by the rasterizer 102 becomes greater than the printing speed, and the amount of image data stored in the storage device 12 increases as time elapses.

Subsequently, as time elapses, the eighth CP is reached and speed control processing is carried out. At the eighth CP, the amount of image data stored in the storage device 12 is less than the lower limit value (yes in S201). Furthermore, at the eighth CP, the amount of image data stored in the storage device 12 is increasing (no in S202) compared to the seventh CP. In this case, the speed controller 106 maintains the conveying speed of the continuous paper P and maintains the printing speed. Therefore, the amount of image data stored in the storage device 12 increases as time elapses.

Subsequently, as time elapses, the ninth CP is reached and speed control processing is carried out. At the ninth CP, the amount of image data stored in the storage device 12 is greater than the lower limit value (no in S201) and is less than the upper limit value (no in S206). Furthermore, at the ninth CP, the amount of image data stored in the storage device 12 is increasing (yes in S207) compared to the eighth CP. In this case, the speed controller 106 causes the conveying speed of the continuous paper P to increase (S208) and causes the printing speed to increase. Even in this case, the image data conversion speed implemented by the rasterizer 102 is greater than the printing speed, and the amount of image data stored in the storage device 12 increases as time elapses.

As described above, in the present exemplary embodiment, the conveying speed of the continuous paper P is controlled based on the amount of image data stored in the storage device 12 and changes in this amount of data, and the amount of image data stored in the storage device 12 is made to be greater than zero and less than the maximum amount.

### <Method for Deciding Lower Limit Value>

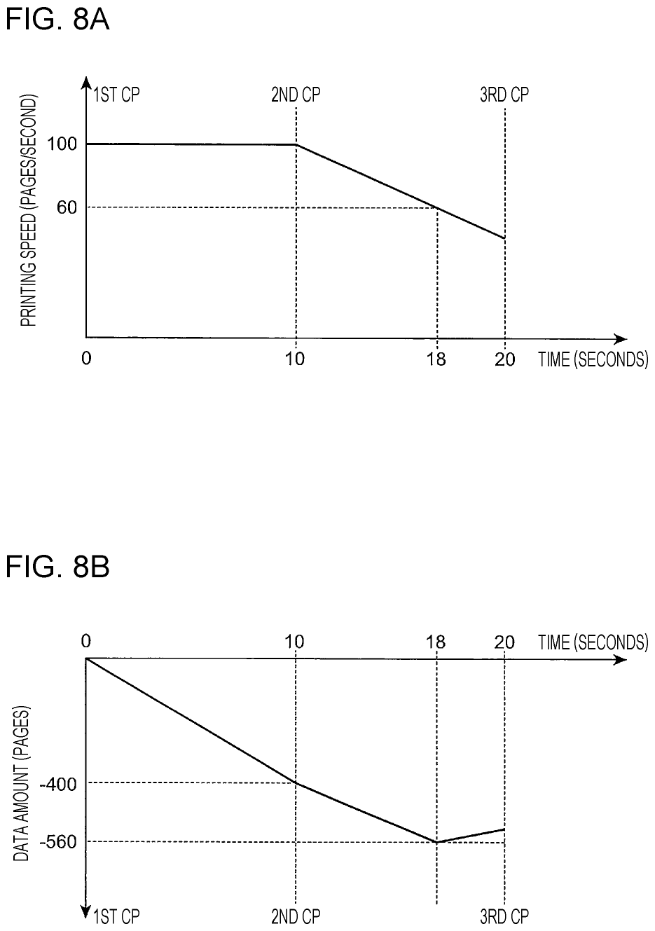

Next, a method for deciding the lower limit value for the amount of image data stored in the storage device 12 will be described. FIG. 8A is a drawing depicting changes in printing speed with respect to time, and FIG. 8B is a drawing depicting changes in the amount of image data stored in the storage device 12 with respect to time.

In the example described hereinafter, the highest speed for printing is 100 pages/second, and the lowest speed for image data conversion implemented by the rasterizer 102 is 60 pages/second. Furthermore, the time from one CP to the next CP is 10 seconds. Furthermore, it is possible for the printing speed to be decreased at a speed of 5 pages/second. Here, the unit for the printing speed is the number of pages on which printing is carried out per 1 second. Furthermore, the unit for the image data conversion speed is the number of pages that correspond to the image data converted per 1 second.

Furthermore, the “highest speed” for printing is the largest value for speed that can be set in the image forming device 20 and the server device 10 as the printing speed. Furthermore, the “highest speed” for printing is the largest value for the printing speed that can be realized with the functions of the image forming device 20. Furthermore, the “highest speed” for printing may be the largest value for the printing speed obtained by carrying out printing with the image forming device 20 as a test. Furthermore, the “highest speed” for printing may be a value indicated in the image forming device 20 or specifications for the image forming device 20 as the highest speed for printing.

Furthermore, the “lowest speed” for image data conversion implemented by the rasterizer 102 is the smallest value for speed that can be realized with the functions of the server device 10. Furthermore, the “lowest speed” for conversion may be the smallest value for the conversion speed obtained by carrying out the image data conversion by the rasterizer 102 as a test. Furthermore, the “lowest speed” for conversion may be a value indicated in the server device 10 or specifications for the server device 10 as the lowest speed for image data conversion.

As depicted in FIG. 8A, printing is carried out for 10 seconds from one CP (first CP) to the next CP (second CP) in accordance with the printing speed of 100 pages/second and the image data conversion speed of 60 pages/second. The speed controller 106 then causes the printing speed to decrease for 10 seconds from the second CP to the next CP (third CP). In this case, the printing speed which was 100 pages/second at the second CP is decreased at a speed of 5 pages/second, and as a result the printing speed becomes 60 pages/second when 8 seconds have elapsed from the second CP. In other words, the printing speed becomes the same value as the image data conversion speed. Furthermore, in this case, the average printing speed during these 8 seconds from the second CP is 80 pages/second.

Furthermore, as described above, in a case where printing is carried out in accordance with the printing speed of 100 pages/second and the image data conversion speed of 60 pages/second, the amount of image data stored in the storage device 12 decreases at a speed of 40 pages/second. Therefore, when printing is carried out for 10 seconds from the first CP to the second CP in accordance with the printing speed and the image data conversion speed described with reference to FIG. 8A, the amount of image data stored in the storage device 12 decreases by (40×10)=400 pages, as depicted in FIG. 8B. Furthermore, in a case where printing is carried out in accordance with the printing speed of 80 pages/second and the image data conversion speed of 60 pages/second, the amount of image data stored in the storage device 12 decreases at a speed of 20 pages/second. Therefore, when printing is carried out for 8 seconds from the second CP in accordance with the printing speed and the image data conversion speed described with reference to FIG. 8A, the amount of image data stored in the storage device 12 decreases by (20×8)=160 pages. In other words, from the first CP to the printing speed becoming the image data conversion speed, the amount of image data stored in the storage device 12 decreases by (400+160)=560 pages. Then, in this case, the lower limit value for the amount of image data stored in the storage device 12 is set to 560 pages.

In other words, in the present exemplary embodiment, a lower limit value is determined so as to suppress a situation where the image data conversion is not in synchronization with printing, even in a case where printing is carried out from one CP to the next CP in accordance with the lowest speed for image data conversion and the highest speed for printing.

In the speed control processing (see FIG. 6), if the amount of image data stored in the storage device 12 is greater than or equal to the lower limit value, the printing speed is not decreased, and therefore there are cases where printing is carried out in accordance with the lowest speed for image data conversion and the highest speed for printing, from the first CP to the second CP (see FIG. 8A). Furthermore, even in a case where control is carried out to decrease the printing speed at the second CP, the amount of image data stored in the storage device 12 decreases until the printing speed becomes the same value as the image data conversion speed. Thus, in the present exemplary embodiment, the lower limit value is determined as being the largest amount of decrease in the amount of image data in the storage device 12 from the first CP to the printing speed becoming the same value as the image data conversion speed.

As described above, in the present exemplary embodiment, the processor 11 determines whether or not the conveying speed is to be decreased at each predetermined time interval. Furthermore, the processor 11 causes the conveying speed to decrease in a case where the amount of image data stored in the storage device 12 is less than the lower limit value. Also, the lower limit value is determined based on the image data conversion speed, the length of the predetermined time interval, and the printing speed. In particular, in the present exemplary embodiment, the lower limit value is greater than the amount of decrease in the image data in the storage device 12 during the predetermined time interval in a case where image data conversion is carried out according to the lowest speed and printing is carried out according to the highest speed. Here, the lower limit value is treated as a predetermined first amount.

### <Method for Deciding Upper Limit Value>

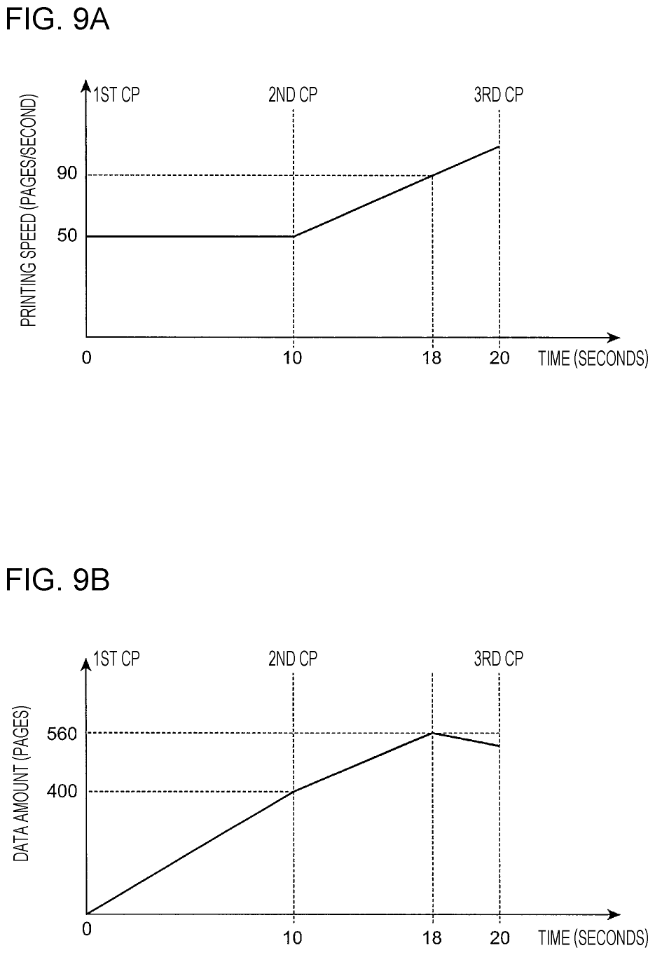

Next, a method for deciding the upper limit value for the amount of image data stored in the storage device 12 will be described. FIG. 9A is a drawing depicting changes in printing speed with respect to time, and FIG. 9B is a drawing depicting changes in the amount of image data stored in the storage device 12 with respect to time.

In the example described hereinafter, the lowest speed for printing is 50 pages/second, and the highest speed for image data conversion implemented by the rasterizer 102 is 90 pages/second. Furthermore, the time from one CP to the next CP is 10 seconds. Furthermore, it is possible for the printing speed to be increased at a speed of 5 pages/second.

It should be noted that, the “lowest speed” for printing is the smallest value for speed that can be set in the image forming device 20 and the server device 10 as the printing speed. Furthermore, the “lowest speed” for printing may be the smallest value for the printing speed that can be realized with the functions of the image forming device 20. Furthermore, the “lowest speed” for printing may be the smallest value for the printing speed obtained by carrying out printing with the image forming device 20 as a test. Furthermore, the “lowest speed” for printing may be a value indicated in the image forming device 20 or specifications for the image forming device 20 as the lowest speed for printing.

Furthermore, the “highest speed” for image data conversion implemented by the rasterizer 102 is the largest value for speed that can be realized with the functions of the server device 10. Furthermore, the “highest speed” for conversion may be the largest value for the conversion speed obtained by carrying out the image data conversion by the rasterizer 102 as a test. Furthermore, the “highest speed” for conversion may be a value indicated in the server device 10 or specifications for the server device 10 as the highest speed for image data conversion.

As depicted in FIG. 9A, printing is carried out for 10 seconds from one CP (first CP) to the next CP (second CP) in accordance with the printing speed of 50 pages/second and the image data conversion speed of 90 pages/second. The speed controller 106 then causes the printing speed to increase for 10 seconds from the second CP to the next CP (third CP). In this case, the printing speed which was 50 pages/second at the second CP is increased at a speed of 5 pages/second, and as a result the printing speed becomes 90 pages/second when 8 seconds have elapsed from the second CP. In other words, the printing speed becomes the same value as the image data conversion speed. Furthermore, in this case, the average printing speed during these 8 seconds from the second CP is 70 pages/second.

Furthermore, as described above, in a case where printing is carried out in accordance with the printing speed of 50 pages/second and the image data conversion speed of 90 pages/second, the amount of image data stored in the storage device 12 increases at a speed of 40 pages/second. Therefore, when printing is carried out for 10 seconds from the first CP to the second CP in accordance with the printing speed and the image data conversion speed described with reference to FIG. 9A, the amount of image data stored in the storage device 12 increases by (40×10)=400 pages, as depicted in FIG. 9B. Furthermore, in a case where printing is carried out in accordance with the printing speed of 70 pages/second and the image data conversion speed of 90 pages/second, the amount of image data stored in the storage device 12 increases at a speed of 20 pages/second. Therefore, when printing is carried out for 8 seconds from the second CP in accordance with the printing speed and the image data conversion speed described with reference to FIG. 9A, the amount of image data stored in the storage device 12 increases by (20×8)=160 pages. In other words, from the first CP to the printing speed becoming the image data conversion speed, the amount of image data stored in the storage device 12 increases by (400+160)=560 pages. Then, in this case, the upper limit value for the amount of image data stored in the storage device 12 is set to a value obtained by subtracting the amount of data for 560 pages from an upper limit for the amount of data that can be stored in the storage device 12.

In other words, in the present exemplary embodiment, an upper limit value is determined so as to suppress a situation where the storage device 12 no longer has space for the image data converted by the rasterizer 102, even in a case where printing is carried out from one CP to the next CP in accordance with the highest speed for image data conversion and the lowest speed for printing.

In the speed control processing (see FIG. 6), if the amount of image data stored in the storage device 12 is less than or equal to the upper limit value, there are cases where the printing speed is not increased, and therefore there are cases where printing is carried out in accordance with the highest speed for image data conversion and the lowest speed for printing, from the first CP to the second CP (see FIG. 9A). Furthermore, even in a case where control is carried out to increase the printing speed at the second CP, the amount of image data stored in the storage device 12 increases until the printing speed becomes the same value as the image data conversion speed. Thus, in the present exemplary embodiment, the upper limit value is determined taking into consideration the largest amount of increase in the amount of image data in the storage device 12 from the first CP to the printing speed becoming the same value as the image data conversion speed. Here, the upper limit value is treated as a predetermined second amount.

Hereinabove, an exemplary embodiment of the present disclosure has been described; however, the technical scope of the present disclosure is not restricted to the scope described in the aforementioned exemplary embodiment. It is clear from the description of the scope of the patent claims that exemplary embodiments obtained by adding various alterations or improvements to the aforementioned exemplary embodiment are also included in the technical scope of the present disclosure.

In the present exemplary embodiment, the processor 11 alters the conveying speed of the continuous paper P by a predetermined speed in a case where the conveying speed is to be altered; however, the present disclosure is not restricted thereto.

The processor 11 may set the degree of alteration in the conveying speed of the continuous paper P in accordance with the amount of change in the amount of data at the current CP with respect to the amount of data at the previous CP. For example, the processor 11 may make the degree of increase in the conveying speed large when there is a large increase in the amount of data at the current CP with respect to the amount of data at the previous CP. Furthermore, for example, the processor 11 may make the degree of decrease in the conveying speed large when there is a large decrease in the amount of data at the current CP with respect to the amount of data at the previous CP.

Furthermore, in the present exemplary embodiment, the processor 11 controls the conveying speed of the continuous paper P on the basis of changes in the amount of image data stored in the storage device 12; however, the present disclosure is not restricted thereto.

The processor 11 may control the conveying speed of the continuous paper P on the basis of the image data conversion speed implemented by the rasterizer 102 and the printing speed. In this case, for example, the processor 11 calculates the image data conversion speed implemented by the rasterizer 102. Furthermore, the processor 11 acquires information relating to the printing speed from the controller 216 of the image forming device 20. Then, in a case where the printing speed is greater than the image data conversion speed, the processor 11 may cause the printing speed to decrease by causing the conveying speed of the continuous paper P to decrease. Furthermore, in a case where the image data conversion speed is greater than the printing speed, the processor 11 may cause the printing speed to increase by causing the conveying speed of the continuous paper P to increase.

Furthermore, in the present exemplary embodiment, an ink jet printer is used as the image forming device 20; however, the present disclosure is not restricted thereto.

For example, an image forming device in which a toner image is formed on the continuous paper P using an electrophotographic system may be used as the image forming device 20.

Furthermore, the processor 11 in the aforementioned exemplary embodiment refers to a processor in a broad sense, and includes general processors (CPUs (central processing units) or the like) and dedicated processors (GPUs (graphics processing units), ASICs (application integrated circuits), FPGAs (field programmable gate arrays), programmable logic devices, and the like).

Furthermore, the operation of the processor 11 in the aforementioned exemplary embodiment may be executed independently by one processor or may be executed by collaboration between multiple processors that are located physically apart from each other. Furthermore, the order in which the operations are executed in the processor is not restricted to only the order described in the aforementioned exemplary embodiment and may be changed.

Furthermore, in the present exemplary embodiment, a configuration is adopted in which the server device 10 controls the conveying speed of the continuous paper P; however, the present disclosure is not restricted thereto.

For example, the image forming device 20 may have a function that controls the conveying speed of the continuous paper P. In other words, a configuration may be adopted in which the processor 11 and the storage device 12 provided in the server device 10 are provided in the controller 216 of the image forming device 20. Also, the controller 216 may be provided with functions for the instruction receiver 101, the rasterizer 102, the transmitter 103, the timer 104, the calculation unit 105, the speed controller 106, and the like. Therefore, the image forming device 20 is also treated as an information processing device in a broad sense.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising a processor configured to:
convert data for which a data print instruction has been issued, into image data of a format used for image forming carried out by an image former, and store the image data in a memory;
cause the image forming, which is based on the image data stored in the memory, to be carried out on a recording medium that is continuously conveyed by a conveyor; and
control a conveying speed of the recording medium being conveyed by the conveyor, on the basis of the image data stored in the memory.

2. The information processing device according to claim 1,
wherein the processor causes the conveying speed to decrease, on the basis of an amount of the image data stored in the memory and changes in the amount of image data.

3. The information processing device according to claim 2,
wherein the processor
determines, at each predetermined time interval, whether or not the conveying speed is to be decreased, and
causes the conveying speed to decrease in a case where the amount of image data is less than a predetermined first amount,
the first amount being determined based on a conversion speed of the image data, a length of the time interval, and a printing speed.

4. The information processing device according to claim 3,
wherein the first amount is greater than an amount of decrease in the image data in the memory during the time interval in a case where conversion of the image data is carried out according to a lowest speed and the printing is carried out according to a highest speed.

5. The information processing device according to claim 1,
wherein the processor causes the conveying speed to increase, on the basis of an amount of the image data stored in the memory and changes in the amount of image data.

6. The information processing device according to claim 5,
wherein the processor causes the conveying speed to increase regardless of changes in the amount of image data, in a case where the amount of image data is greater than a predetermined second amount.

7. The information processing device according to claim 5,
wherein the processor causes the conveying speed to increase in a case where the amount of image data is greater than a predetermined first amount and an amount of change per predetermined time interval in the amount of image data is a positive value.

8. The information processing device according to claim 1,
wherein the processor
causes the conveying speed to decrease in a case where an amount of the image data stored in the memory is less than a predetermined first amount and an amount of change per predetermined time interval in the amount of image data is a negative value,
causes the conveying speed to increase in a case where the amount of image data is greater than the first amount and the amount of change is a positive value, and
does not cause the conveying speed to increase in a case where the amount of image data is greater than the first amount and the amount of change is a negative value.

9. An image forming system comprising a processor configured to:
convert data for which a data print instruction has been issued, into image data of a format used for image forming carried out by an image former, and store the image data in a memory;
cause the image forming, which is based on the image data stored in the memory, to be carried out on a recording medium that is continuously conveyed by a conveyor, at a time at which the recording medium is conveyed to a predetermined location; and
control a conveying speed of the recording medium being conveyed by the conveyor, on the basis of the image data stored in the memory.

10. The image forming system according to claim 9,
wherein the image forming is carried out by ink being discharged onto the recording medium, and
the processor, together with controlling the conveying speed, controls a drying temperature implemented by a drier that dries the ink discharged onto the recording medium, and controls a cooling temperature implemented by a cooler that cools the recording medium dried by the drier.

11. A non-transitory computer readable medium storing a program causing a computer to execute a process comprising:
converting data for which a data print instruction has been issued, into image data of a format used for image forming carried out by an image former, and storing the image data in a memory;
causing the image forming, which is based on the image data stored in the memory, to be carried out on a recording medium that is continuously conveyed by a conveyor; and
controlling a conveying speed of the recording medium being conveyed by the conveyor, on the basis of the image data stored in the memory.

12. An information processing device comprising:
data conversion means for converting data for which a data print instruction has been issued, into image data of a format used for image forming, and storing the image data in a memory;
image forming means for carrying out the image forming, which is based on the image data stored in the memory, on a recording medium that is continuously conveyed by a conveyor; and
control means for controlling a conveying speed of the recording medium being conveyed by the conveyor, on the basis of the image data stored in the memory.
